(19) United States
(12) Patent Application Publication
(10) Pub. No.: US 2013/0192723 A1
(43) Pub. Date: Aug. 1, 2013

(54) METHOD FOR MANUFACTURING BONDED MAGNET

(71) Applicant: MINEBEA CO., LTD., Kitasaku-gun (JP)

(72) Inventors: Haruhiro KOMURA, Toyohashi-shi (JP); Noboru MENJO, Fukuroi-shi (JP); Toshinori SUZUKI, Syuchi-gun (JP)

(73) Assignee: MINEBEA CO., LTD., Kitasaku-gun (JP)

(21) Appl. No.: 13/718,590

(22) Filed: Dec. 18, 2012

(30) Foreign Application Priority Data
Jan. 31, 2012 (JP) 2012-017886

(51) Int. Cl. H01F 41/02

(52) U.S. Cl. CPC H01F 41/028
USPC 148/103

(57) ABSTRACT

A method for manufacturing a magnetized bonded magnet, including the steps of: arranging a magnetization permanent magnet for magnetizing a magnetic field near a non-magnetized bonded magnet; heating the non-magnetized bonded magnet to a temperature of a Curie point thereof or higher; and continuously magnetizing the magnetic field to the non-magnetized bonded magnet by the magnetization permanent magnet for magnetizing the magnetic field while cooling the non-magnetized bonded magnet reached at the temperature of the Curie point thereof or higher to a temperature of less than the Curie point, wherein the non-magnetized bonded magnet is a rare-earth iron bonded magnet including two or more different rare-earth elements in magnet powder thereof.

### TECHNICAL FIELD

The present invention relates to a method for manufacturing a bonded magnet, in particular, a magnetized bonded magnet.

### BACKGROUND ART

In recent years, in response to remarkable downsizing of electronic apparatuses, stepping motors and the like which are used in these apparatuses have been also miniaturized and reduced in diameter. With this, ring-shaped permanent magnets which are used as rotor have been also reduced in diameter. Thus, a magnetization pitch (a magnetization distance between poles) becomes narrow, causing a difficulty in multi-pole magnetization.

As a method for multi-pole magnetization, pulse magnetization is known in the art. In the pulse magnetization, when magnetizing a ring-shaped permanent magnet, a large pulse current is applied to a magnet wire. When a magnetization pitch becomes narrow with a reduction in diameter of ring-shaped permanent magnet, in magnetization fixtures under present circumstances, magnetic wires have smaller diameters. Thus, the magnetization fixtures have problems of difficulty in applying pulse current enough to magnetize magnetics. As a technique for improving the problems, a method that reduces a magnetic field for saturated magnetization by heating a magnetization subject to a high temperature of less than Curie point is known in the art [see, for example, Japanese Patent No. 2940048 (Patent Literature 1) and Japanese Unexamined Patent Application Publication No. 6-140248 (Patent Literature 2)]. Regarding a method for magnetization of permanent magnet, furthermore, there is known a permanent-magnet magnetization method by which a temperature of a magnetization subject is lowered from its Curie point or higher to less than its Curie point, and a permanent magnet continuously applies a magnetic field to a magnetization subject during such a temperature-lowering period [see, for example, Japanese Unexamined Patent Application Publication No. 2006-203173 (Patent Literature 3)].

However, the magnetization methods of Japanese Patent No. 2940048 (Patent Literature 1) and Japanese Unexamined Patent Application Publication No. 6-140248 (Patent Literature 2) do not provide sufficient magnetization characteristics. In addition, possibility of insulation breakdown cannot be avoided because electric current passes through a magnetic wire of a magnetization coil. Since a magnetization fixture is subjected to high temperature, its component parts, especially mold resin, is deteriorated to shorten the life of the magnetization fixture. According to a magnetization method of Japanese Unexamined Patent Application Publication No. 2006-203173 (Patent Literature 3), high magnetization characteristics are obtained in neodymium-iron-boron (Nd—Fe—B) bonded magnets. However, since an adjustable range of magnetization characteristics depends on physical properties of magnetic particles, such a range typically becomes narrow and leads to difficulty in obtaining desired magnetization characteristics. Furthermore, because of increases in rare-earth prices, requests have been made of cheaper rare-earth bonded magnets having high characteristics.

### SUMMARY OF INVENTION

### Technical Program

The present invention has been made in consideration of such a situation, and an object of the present invention is to provide a method for manufacturing a bonded magnet in a simple manner with lower costs, where the bonded magnet has a wide adjustable range of magnetization characteristics while keeping high magnetization characteristics.

### Solution to Problem

In order to attain the above object, in a first aspect of the present invention, a method for manufacturing a magnetized bonded magnet comprises the steps of: arranging means for magnetizing a magnetic field near a non-magnetized bonded magnet; heating the non-magnetized bonded magnet to a temperature of a Curie point thereof or higher; and continuously magnetizing the magnetic field to the non-magnetized bonded magnet by the means for magnetizing the magnetic field while cooling the non-magnetized bonded magnet reached at the temperature of the Curie point thereof or higher to a temperature of less than the Curie point, wherein the non-magnetized bonded magnet is a rare-earth iron bonded magnet including two or more different rare-earth elements in magnet powder thereof.

In a second aspect of the present invention, in the method according to the first aspect, the non-magnetized bonded magnet is formed in a ring shape and surrounded with a plurality of the means for magnetizing magnetic field so as to be multi-pole magnetized.

In a third aspect of the present invention, in the method according to the first or the second aspect, the rare-earth elements may have an atomic percentage of 12 at % or more in total amount.

In a fourth aspect of the present invention, in the method according to the first aspect, the magnet powder may have an intrinsic coercive force of 716 kA/m (9 kOe) or more.

In a fifth aspect of the present invention, in the method according to the first or the second aspect, the rare-earth elements may include neodymium (Nd) and prasodymium (Pr).

In a sixth aspect of the present invention, in the method according to the fifth aspect, the Nd and the Pr may have a mixing ratio of 5 at % to 50 at % as a substitution amount of Pr with respect to an amount of Nd.

In a seventh aspect of the present invention, in the method according to the first aspect, the non-magnetized bonded magnet may be free of cobalt (Co).

### Advantageous Effects of Invention

According to the present invention, a decrease in Curie temperature, a decrease in thermal demagnetization characteristics, and so on can be utilized to obtain a method for manufacturing an industrially useful bonded magnet (with high magnetic characteristics, comparatively wide adjustable range of magnetization characteristics, and low costs).

### BRIEF DESCRIPTION OF DRAWINGS

FIG. 1a is a plan view of a magnetization fixture and a bonded magnet according to an embodiment and FIG. 1b is a vertical cross-sectional view thereof.

FIG. 2 is a plan view illustrating a situation of multi-pole magnetization given to the bonded magnet.

FIG. 3 is a diagram illustrating an example of measurement results of surface magnetic flux density of 10-pole magnetization.

FIG. 4 is a diagram illustrating magnetization characteristics of Example 1, Example 2, and Comparative Example 1.

FIG. 5 is a diagram illustrating magnetization characteristics of Example 1, Example 2, and Comparative Example 3.

FIG. 6 is a diagram illustrating magnetization characteristics of Example 1, Example 2, and Comparative Example 4.

FIG. 7 is a diagram illustrating a magnetization characteristics reduction rate at higher temperature with reference to magnetization characteristics at a thermostatic temperature of 50° C.

FIG. 8 is a diagram illustrating magnetization characteristics of Example 1, Example 2, Comparative Example 3, and Comparative Example 4.

FIG. 9 is a diagram illustrating magnetization characteristics of Example 1, Comparative Example 5, and Comparative Example 6.

### DESCRIPTION OF EMBODIMENTS

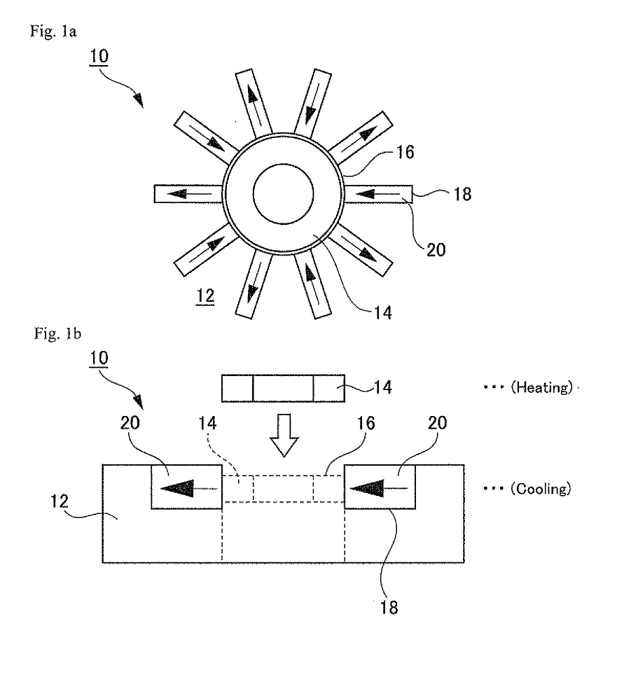

Hereinafter, a method for manufacturing a magnetized bonded magnet according to the present invention will be described in detail with reference to embodiments. In FIG. 1a and FIG. 1b, a bonded magnet 14 is illustrated as each of a magnetization fixture 10 and a magnetization subject to be used in a method for manufacturing a magnetized bonded magnet of an embodiment. Here, FIG. 1a represents a plan view and FIG. 1b represents a vertical cross-sectional view. In the embodiment, a ring-shaped bonded magnet 14 is subjected to 10-paler magnetization to produce a multi-pole magnetized bonded magnet 140. Here, elements will be represented by both names and atomic symbols in first appearance and then represented only by atomic symbols in subsequent appearances.

A magnetization fixture 10 includes a nonmagnetic block (e.g., stainless steel block) 12 having a circular magnetization subject housing hole 16 in which a bonded magnet 14 is removably inserted, and ten square section grooves 18 radially extending from an outer side of the magnetization subject housing hole 16 at equal angled intervals. Magnetization permanent magnets 20 are respectively disposed in the grooves 18 and serve as means for magnetizing a magnetic field, having a higher Curie point than the bonded magnet 14 and having a square-section bar shape. For example, the magnetization permanent magnet 20 may be a samarium cobalt SmCo sintered magnet having a Curie point of about 850° C.

Hereinafter, described is a method for manufacturing a multi-pole magnetized bonded magnet 140 from the bonded magnet 14. The method for manufacturing the multi-pole magnetized bonded magnet 140 comprises the steps of: heating the bonded magnet 14 to a temperature of its Curie point or higher after arranging the magnetization permanent magnets 20 near the bonded magnet 14; and magnetizing the bonded magnet 14 by continuously magnetizing a magnetic field to the bonded magnet 14 by the magnetization permanent magnet 20 while cooling the bonded magnet 14 reached at the temperature of the Curie point thereof or higher to a temperature of less than the Curie point.

As the bonded magnet 14, prepared is a rare-earth iron bonded magnet that includes two or more different rare-earth elements. Inclusion of two or more different rare-earth elements lowers refinement costs. Thus, a rare-earth iron bonded magnet can be provided in reasonable price. Table 1 represents magnetic characteristics of a rare-earth iron boron magnet (R₂Fe₁₄B). For example, a rare-earth iron bonded magnet used is one in which part of neodymium Nd (hereinafter referred to merely Nd) having a highest saturation magnetization is partially substituted with an element having magnetic characteristics similar to those of yttrium Y, cerium Ce, praseodymium Pr (hereinafter referred to merely Pr), or the like while keeping its magnetic characteristics less affected by such substitution. Here, a costly preferable combination is a combination similar to a naturally-occurring form as much as possible and more preferably a combination of elements each having high magnetic characteristics. Particularly, both Nd and Pr have magnetically similar physical properties, and thus a decrease in static magnetic characteristics can be suppressed to the minimum. As long as Nd and Pr have a mixing ratio of preferably 5 at % to 50 at %, more preferably 10 at % to 35 at % as a substitution amount of Pr with respect to an amount of Nd, the ratio approximates one produced in nature and cost reduction can be thus attained.

TABLE 1

| | Saturated | | Aniso- | Anisotropic | (BH)max |
|---|---|---|---|---|---|
| R₂Fe₁₄B | Magneti- | Curie | tropic | Magnetic | Theoretical |
| Com- | zation | Point | Constant | Field | Value |
| pound | Is(T) | Tc(° C.) | K(MJ/m³) | HA(MA/m) | (Kj/m³) |
| Y₂Fe₁₄B | 1.42 | 298 | 1.41 | 1.59 | 400 |
| Ce₂Fe₁₄B | 1.17 | 149 | 1.76 | 2.39 | 272 |
| Pr₂Fe₁₄B | 1.56 | 296 | 6.79 | 6.93 | 484 |
| Nd₂Fe₁₄B | 1.60 | 313 | 5.36 | 5.33 | 509 |
| Sm₂Fe₁₄B | 1.52 | 347 | plane | — | 460 |
| Gd₂Fe₁₄B | 0.893 | 386 | 1.12 | 2 | 158 |
| Tb₂Fe₁₄B | 0.703 | 347 | 7.73 | 17.51 | 98 |
| Dy₂Fe₁₄B | 0.712 | 325 | 5.34 | 11.94 | 100 |
| Ho₂Fe₁₄B | 0.807 | 300 | 3.03 | 5.97 | 129 |
| Er₂Fe₁₄B | 0.899 | 278 | plane | — | 160 |
| Tm₂Fe₁₄B | 0.925 | 276 | plane | — | 263 |
| Lu₂Fe₁₄B | 1.183 | 262 | — | — | 280 |

(Source: http://www.catnet.ne.jp/triceps/pub/sample/cs003.pdf)

In the heating step, the bonded magnet 14 is inserted in the magnetization subject holding hole 16 while being heated at a temperature higher than the Curie point. In the magnetization step, a magnetization magnetic field is applied to the bonded magnet 14 by using the magnetization permanent magnet 20. Furthermore, the bonded magnet 14 is cooled to a temperature of the Curie point of the bonded magnet 14 or less while being placed in the magnetization fixture 10, followed by being pulled out of the magnetization fixture 10. For example, when the Curie point of the bonded magnet 14 is set to Tc, it is particularly preferable that the bonded magnet 14 be heated to a temperature of (Tc+30° C.) or more and then cooled to a temperature of (Tc−50° C.) in a magnetization magnetic field. Here, the heating may be performed by any means, such as resistance heating, high-frequency heating, laser heating, high-temperature gas-flow heating, or heating in high-temperature liquid. Among them, particularly preferable is the high-frequency heating method that allows short-time heating. The cooling may be performed by any method, such as natural radiation cooling, water cooling, air cooling, compulsive radiation cooling (e.g., gas spraying), and heating temperature adjustment. If there is a need of working under inactive atmosphere, an inactive gas flow is performed. A moving mechanism (not shown) allows each of the bonded magnet 14 and the multi-pole magnetized bonded magnet 140 to be easily, quickly inserted in the magnetization subject holding hole 16 of the magnetization fixture 10 and easily, quickly pulled out of the magnetization subject holding hole 16.

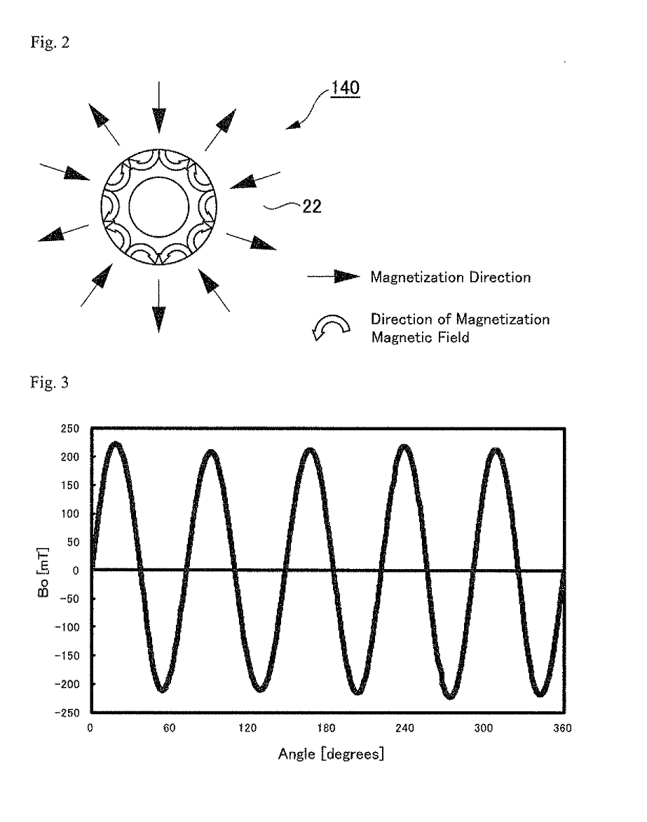

By carrying out the steps described above, an outer peripheral surface of the permanent magnet, the bonded magnet 14, generates a magnetic pole corresponding to the magnetized pole. As a result, a multi-pole magnetized bonded magnet 140 can be obtained. FIG. 2 is a plan view illustrating a situation of multi-pole magnetization performed on a rink-shaped permanent magnet, the multi-pole magnetized bonded magnet 140. Reference numeral 22 represents a direction of magnetization magnetic field.

Evaluation of magnetization characteristics can be quantitatively performed by measuring a surface inductive flux with a tesla meter. FIG. 3 is a diagram illustrating measured surface inductive fluxes (open) Bo [mT] at center angles [degrees] with respect to arbitrary points on the outer peripheral surface of multi-pole magnetized bonded magnet 140. As shown in FIG. 3, the measurement can be performed by successively measuring changes in surface influx density (open) Bo [mT] at center angles (degrees) with respect to arbitrary points on the outer peripheral surface of multi-pole magnetized bonded magnet 140. In the following examples, an average value of Bo peak values (absolute values) of all poles is represented as magnetization characteristics.

Hereinafter, the present invention will be described in more detail with reference to examples and comparative examples. Bonded magnets 14 used in the following examples and comparative examples were compression-molded bonded magnets each having an external diameter φ of 2.6 mm, an inner diameter φ of 1.0 mm, and a thickness of 3 mm. In other words, the magnets used have the same dimensions and weight (i.e., their densities are equal). Furthermore, these magnets 14 were subjected to 10-pole magnetization (pole pitch 0.8 mm) from their outer peripheries, showing magnetization characteristics. Magnet powder was molded by pulverizing a rapidly cooled thin strip and mixing the magnet powder with epoxy resin as binder resin in an amount of 2.5 wt %. Magnetization was performed using the magnetization fixture 10 at a heating temperature of 380° C. for 3 sec., and then cooled to a thermostatic temperature. After 6 seconds, a multi-pole magnetized bonded magnet 140 was pulled out and obtained.

As described below, changes in magnetization characteristics depending on a total amount of rare-earth elements were measured for Example 1, Example 2, and Comparative Example 1. Thermostatic temperatures in these examples were 50° C., respectively.

### EXAMPLE 1

A rare-earth iron boron bonded magnet 14 using rare-earth elements Nd and Pr was employed and a total amount of the rare-earth elements was set to 12 at %.

### EXAMPLE 2

A rare-earth iron boron bonded magnet 14 using rare-earth elements Nd and Pr was employed and a total amount of the rare-earth elements was set to 12.5 at %.

### COMPARATIVE EXAMPLE 1

A rare-earth iron boron bonded magnet 14 using rare-earth elements Nd and Pr was employed and a total amount of the rare-earth elements was set to 10 at %.

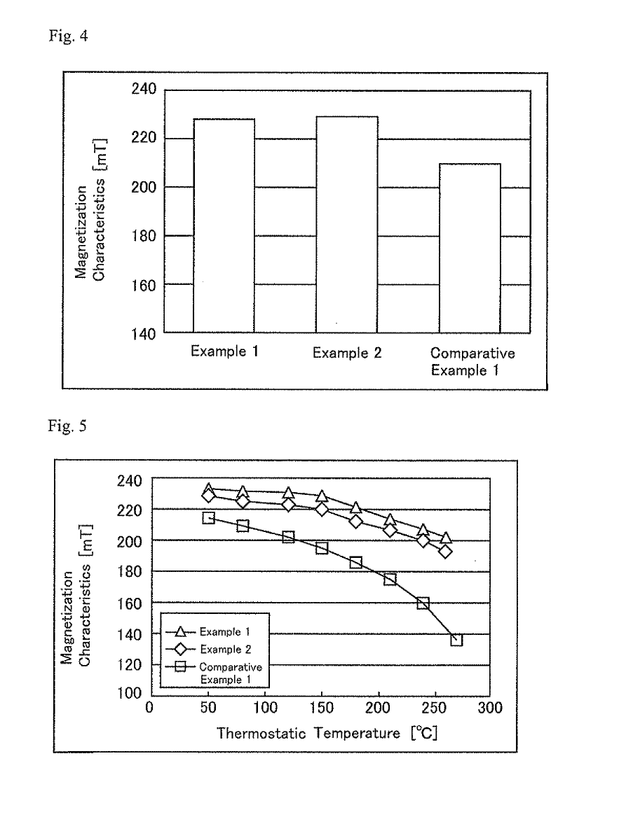

FIG. 4 is a diagram illustrating magnetization characteristics of Example 1, Example 2, and Comparative Example 1. In FIG. 4, it is found that setting the total amount of rare-earth elements to 12 at % or more exerts an action of suppressing initial demagnetization to give a multi-pole magnetized bonded magnet 140 having high magnetization characteristics.

As described below, changes in magnetization characteristics due to intrinsic coercive forces depending on thermostatic temperatures were measured for Example 1, Example 2, and Comparative Example 1.

### EXAMPLE 1

A magnetic powder having an intrinsic coercive force of 716 kA/m (9 kOe) was prepared using a rare-earth iron boron bonded magnet 14 in which rare-earth elements were Nd and Pr.

### EXAMPLE 2

A magnetic powder having an intrinsic coercive force of 796 kA/m (10 kOe) was prepared using a rare-earth iron boron bonded magnet 14 in which rare-earth elements were Nd and Pr.

### COMPARATIVE EXAMPLE 1

A magnetic powder having an intrinsic coercive force of 557 kA/m (7 kOe) was prepared using a rare-earth iron boron bonded magnet 14 in which rare-earth elements were Nd and Pr.

FIG. 5 is a diagram illustrating magnetization characteristics of Example 1, Example 2, and Comparative Example 1. A horizontal axis illustrates thermostatic temperature (° C.), and a vertical axis illustrates magnetization characteristics (mT). In FIG. 5, use of the magnet powder having an intrinsic coercive force of 716 kA/m (9 kOe) or more allows for obtaining a multi-pole magnetized bonded magnet 140 having high magnetization characteristics, where the bonded magnet has good thermal demagnetization characteristics and an extremely small initial demagnetization level.

### COMPARATIVE EXAMPLE 3

A magnetic powder having an intrinsic coercive force of 716 kA/m (9 kOe) was prepared using a rare-earth iron boron bonded magnet 14 in which a rare-earth element was Nd.

### COMPARATIVE EXAMPLE 4

A magnetic powder having an intrinsic coercive force of 796 kA/m (10 kOe) was prepared using a rare-earth iron boron bonded magnet 14 in which a rare-earth element was Nd.

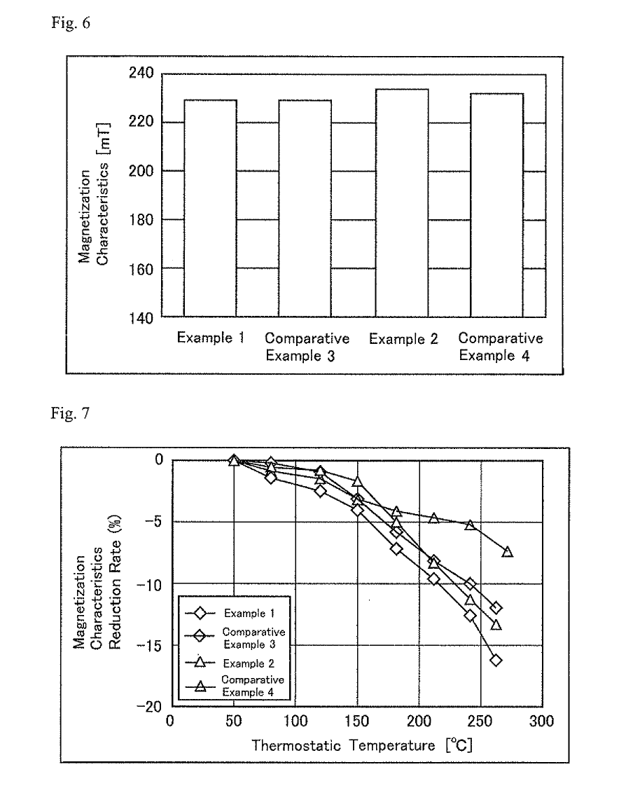

FIG. 6 is a diagram illustrating magnetization characteristics of Example 1, Example 2, Comparative Example 3, and Comparative Example 4 at a thermostatic temperature of 50° C. Furthermore, FIG. 7 is a diagram illustrating a magnetization-characteristics reduction rate at a thermoset temperature in a higher temperature region with reference to magnetization characteristics at a thermoset temperature of 50° C. which is a pulling-out temperature when cooling. In FIG. 6, it is found that a multi-pole magnetized bonded magnet 140 having high magnetic characteristics can be obtained by inclusion of Nd and Pr as rare-earth elements. In FIG. 7, an adjustable range of magnetization characteristics can be extended using the phenomenon of a slightly decrease in thermal demagnetization characteristics. Specifically, it is found that an increase in magnetization characteristics reduction rate can be attained at a thermostatic temperature on a high-temperature side.

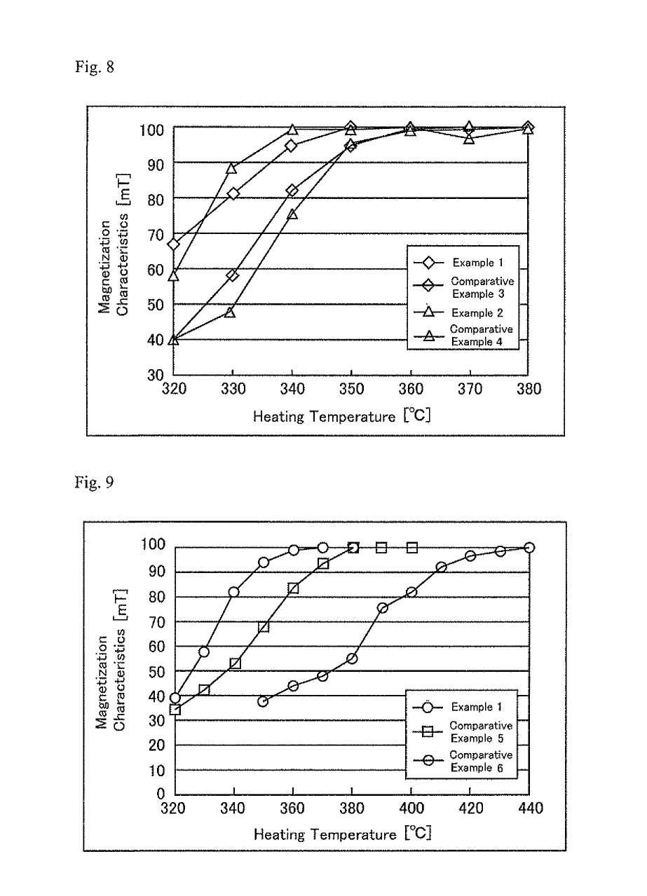

FIG. 8 is a diagram illustrating magnetization characteristics of Example 1, Example 2, Comparative Example 3, and Comparative Example 4. A horizontal axis illustrates heating temperature (° C.), and a vertical axis illustrates magnetization characteristics (mT). The magnetization characteristics (%) represent a ratio of each material to a maximal level. In addition, the thermostatic temperature was 50° C. In FIG. 8, it is found that a decrease in magnetization characteristics is suppressed even after lowering a heating temperature accompanied by a decrease in Curie point. A decrease in Curie point can lower a thermostatic temperature of the magnetizing device to lower a burden on the device, causing an advantageous effect in manufacture. Since heating conditions can be set to lower temperatures, magnetization of a magnet having a large heat capacity can be comparatively easily performed.

### COMPARATIVE EXAMPLE 5

Comparative Example 5 was prepared by adding cobalt Co (hereinafter referred to merely Co) in amount of 1 at % to the bonded magnet 14 of Example 1.

### COMPARATIVE EXAMPLE 6

Comparative Example 6 was prepared by adding Co in amount of 5 at % to the bonded magnet 14 of Example 1. Here, each of Comparative Example 5 and Comparative Example 6 had an intrinsic coercive force of 716 kA/m (9 kOe).

FIG. 9 is a Figure illustrating the magnetization characteristics of Example 1, comparative example 5, and comparative example 6. A horizontal axis illustrates heating temperature (° C.), and a vertical axis illustrates magnetization characteristics (mT). The magnetization characteristics (%) represent a ratio of each material to a maximal level. In addition, the thermostatic temperature was 50° C. In FIG. 9, it is found that the lower the content of Co the more the magnetization characteristics are saturated at low heating temperature. Addition of Co is indispensable for increasing the Curie point of a rare-earth iron magnet and thermally stabilizing the magnet. Since free of CO leads to a decrease in the Curie point as well as a reduction in costs of magnetic materials, and also leads to a decrease in thermal demagnetization characteristics, the rare-earth iron bonded magnet having high magnetization characteristics can be obtained. In addition, a decrease in burden on the device occurs as the magnetization is allowed to be performed under conditions of comparatively low heating temperature, and adjustment of characteristics can be also facilitated. Furthermore, magnetization of a magnet having a large heat capacity can be comparatively easily performed. Since Co is produced as a by-product in production of copper Cu (hereinafter referred to merely Cu) or nickel Ni (hereinafter referred to merely Ni), the amount of production is influenced by Cu or Ni price situation. Thus, a stable supplying system is not always ensured. Therefore, it is desired to achieve desired characteristics and high magnetic characteristics without use of Co as much as possible.

Furthermore, the present invention is not limited to the embodiment described above.

Although the example of magnetizing a ring-shaped magnet as a magnetization subject is described above, the present invention is applicable to magnetization from the inside or both the inside and outside as well as magnetization from the outside. Any of these magnetization methods allows an inner peripheral surface or both the inner and outer peripheral surfaces of a ring-shaped permanent magnet provided as a magnetization subject to generate a magnetic pole corresponding to a magnetized pole. According to the present invention, means for applying magnetization magnetic field may be disposed in two stages instead of disposing it in one stage in an axial direction. Regarding skew magnetization, for example, it can be attained by arranging magnetization permanent magnets inclined at a predetermined angle.

Furthermore, the shape and size of a bonded magnet, the type of magnet powder, the Curie point of the magnet, and the Curie point of a magnetization permanent magnet, and so on may be selected from those other than the embodiments. Furthermore, the present invention can be carried out with various modifications without departing from the gist thereof.

### REFERENCE SIGNS LIST

10 Magnetization fixture
12 Nonmagnetic block
14 Bonded magnet
16 Magnetization subject holding hole
18 Groove
20 Magnetization permanent magnet
22 Direction of magnetization magnetic field
140 multi-pole magnetized bonded magnet

### CITATION LIST

### Patent Literature

Patent Literature 1: Japanese Patent No. 2940048
Patent Literature 2: Japanese Unexamined Patent Application Publication No. 6-140248
Patent Literature 3: Japanese Unexamined Patent Application Publication No. 2006-203173

1. A method for manufacturing a magnetized bonded magnet, comprising the steps of:
arranging means for magnetizing a magnetic field near a non-magnetized bonded magnet;
heating the non-magnetized bonded magnet to a temperature of a Curie point thereof or higher; and
continuously magnetizing the magnetic field to the non-magnetized bonded magnet by the means for magnetizing the magnetic field while cooling the non-magnetized bonded magnet reached at the temperature of the Curie point thereof or higher to a temperature of less than the Curie point,
wherein the non-magnetized bonded magnet is a rare-earth iron bonded magnet including two or more different rare-earth elements in magnet powder thereof.

2. The method according to claim 1, wherein the non-magnetized bonded magnet is formed in a ring shape and surrounded with a plurality of the means for magnetizing magnetic field so as to be multi-pole magnetized.

3. The method according to claim 1, wherein the rare-earth elements have an atomic percentage of 12 at % or more in total amount.

4. The method according to claim 1, wherein the magnet powder has an intrinsic coercive force of 716 kA/m (9 kOe) or more.

5. The method according to claim 1, wherein the rare-earth elements include neodymium (Nd) and praseodymium (Pr).

6. The method according to claim 5, wherein the Nd and the Pr have a mixing ratio of 5 at % to 50 at % as a substitution amount of Pr with respect to an amount of Nd.

7. The method according to claim 1, wherein the non-magnetized bonded magnet is free of cobalt (Co).

8. The method according to claim 2, wherein the rare-earth elements have an atomic percentage of 12 at % or more in total amount.

9. The method according to claim 2, wherein the rare-earth elements include neodymium (Nd) and praseodymium (Pr).

10. The method according to claim 9, wherein the Nd and the Pr have a mixing ratio of 5 at % to 50 at % as a substitution amount of Pr with respect to an amount of Nd.
